(19) United States
(12) Patent Application Publication
(10) Pub. No.: US 2026/0001148 A1
(43) Pub. Date: Jan. 1, 2026

(54) DRILLING TOOL

(71) Applicant: MILWAUKEE ELECTRIC TOOL CORPORATION, Brookfield, WI (US)

(72) Inventors: Travis J. DuMez, Port Washington, WI (US); Venkat K. Vadlamani, Waukesha, WI (US); Julian L. Kinneavy, Wauwatosa, WI (US); Ian H.A. Blair, Wauwatosa, WI (US)

(21) Appl. No.: 19/252,519

(22) Filed: Jun. 27, 2025

Related U.S. Application Data
(60) Provisional application No. 63/665,358, filed on Jun. 28, 2024.

(51) Int. Cl. B23B 51/02

(52) U.S. Cl. CPC B23B 51/02; B23B 2250/16

(57) ABSTRACT

A drilling tool including a shank portion, a drill portion, and a collar. The shank portion includes a shank first end that is configured to be coupled to a power tool and a shank second end opposite the shank first end. The drill portion includes a drill first end, a drill second end, and a cutting head positioned at the drill second end. The collar is configured to dampen vibrations transferred between the shank portion and the drill portion during operation of the drilling tool. The collar includes a collar first end, a collar second end, and an apex. The collar first end is attached to the shank second end. The collar second end is attached to the drill first end. The apex defines a maximum outer dimension of the collar. The apex is positioned between the collar first end and the collar second end.

### CROSS-REFERENCE TO RELATED APPLICATIONS

This application claims priority to U.S. Provisional Application No. 63/665,358, filed Jun. 28, 2024, the entire contents of which are incorporated by reference herein.

### FIELD OF THE INVENTION

The present invention relates to power tool accessories. More specifically, the present invention relates to drill bits or drilling tools.

### BACKGROUND

Drill bits, such as masonry drill bits, are used to drill holes into hard materials such as concrete, cinder block, stone, brick (e.g., red brick), tile, metal, wood, plastic, porcelain, ceramics and the like. Some drill bits can be used with power tools such as hammer drills and impact drills that are operable in a drilling mode which only rotates the masonry drill, a chisel mode which delivers only percussive force to the masonry drill, or a hammer drill mode which rotationally drives the masonry drill and delivers a percussive force to the masonry drill.

### SUMMARY

In one aspect, the disclosure provides a drilling tool including a shank portion, a drill portion, and a collar. The shank portion includes a shank first end that is configured to be coupled to a power tool and a shank second end opposite the shank first end. The drill portion includes a drill first end, a drill second end, and a cutting head positioned at the drill second end. The collar is configured to dampen vibrations transferred between the shank portion and the drill portion during operation of the drilling tool. The collar includes a collar first end, a collar second end, and an apex. The collar first end is attached to the shank second end. The collar second end is attached to the drill first end. The apex defines a maximum outer dimension of the collar. The apex is positioned between the collar first end and the collar second end.

In some aspects, the apex is spaced from each of the collar first end and the collar second end. In further aspects, an outer dimension of the collar at each of the collar first end and the collar second end is less than a maximum outer dimension of the collar at the apex of the collar.

In some aspects, the collar is formed as a separate component from the shank portion, the drill portion, or both.

In some aspects, the shank portion has a first diameter, the drill portion has a second diameter, and the maximum outer dimension of the collar is larger than each of the first dimeter and the second diameter. In further aspects, the first diameter is larger than the second diameter. In further aspects, a ratio of the maximum outer dimension of the collar to the first diameter is at least 1.5. In further aspects, a ratio of the maximum outer dimension of the collar to the first diameter is at least 2.

In some aspects, the drill portion has a drill diameter, the collar has a drill transition length defined between the drill first end and the apex, and a ratio of the drill transition length to the drill diameter is at least 1.

In some aspects, the shank portion has a shank diameter, the collar has a collar length, and a ratio of the collar length to the shank diameter is at least 1.

In another aspect, the disclosure provides a drilling tool including a shank portion, a drill portion, and a collar. The shank portion includes a shank first end that is configured to be coupled to a power tool and a shank second end opposite the shank first end. The drill portion includes a drill first end, a drill second end, and a cutting head positioned at the drill second end. The drill second end and the shank first end define a longitudinal axis extending therethrough. The collar defines a maximum outer dimension of the drilling tool. The collar includes a collar first end, a collar second end, and a transition segment. The collar first end is attached to the shank second end. The collar second end is attached to the drill first end. The transition segment extends from collar second end and gradually away from the longitudinal axis.

In some aspects, the collar further includes an apex that defines the maximum outer dimension of the collar, and the transition segment is positioned between the apex and the collar second end. In further aspects, the drill portion has a drill diameter, the collar has a drill transition length defined between the drill first end and the apex, and a ratio of the drill transition length to the drill diameter is at least 1. In further aspects, the ratio of the drill transition length to the drill diameter is at least 2. In further aspects, the shank portion has a shank diameter, the collar has a shank transition length defined between the shank second end and the apex, and a ratio of the shank transition length to the shank diameter is at least 0.2. In further aspects, the ratio of the shank transition length to the shank diameter is at least 0.5.

In some aspects, the shank portion has a shank diameter, the collar has a collar length, and a ratio of the collar length to the shank diameter is at least 1.

In another aspect, the disclosure provides a method of manufacturing a drilling tool. The method includes forming a shank portion and a drill portion, forming a collar, and attaching the collar to each of the shank portion and the drill portion. The shank portion has a shank first end that is configured to be coupled to a power tool and a shank second end opposite the shank first end. The drill portion has a drill first end, a drill second end, and a cutting head positioned at the drill second end. The collar includes a collar first end and a collar second end. The collar is attached to each of the shank portion and the drill portion such that the collar first end attaches to the shank first end and the collar second end attaches to the drill first end.

In some aspects, the forming the collar includes forming the collar having a maximum outer diameter that is at least 1.5 times as large as a maximum outer dimension of the shank portion and having length that is greater than or equal to the maximum outer dimension of the shank portion.

In some aspects, the forming the collar includes forming the collar having a transition segment extending from the collar second end and gradually away from a longitudinal axis of the drilling tool, the transition segment being at least a same size as an outer diameter of the drill portion.

Other aspects of the invention will become apparent by consideration of the detailed description and accompanying drawings.

### BRIEF DESCRIPTION OF THE DRAWINGS

FIG. 1 is a perspective view of a drilling tool including a shank portion, a drill portion, and a collar according to an embodiment of the disclosure.

FIG. 2 is a plan view of the drilling tool of FIG. 1.

FIG. 3 is another plan view of the drilling tool of FIG. 1.

FIG. 4 is an enlarged view of an end of the drilling tool of FIG. 1.

FIG. 5 is an enlarged view of the collar for the drilling tool of FIG. 1.

FIG. 6 is a cross-sectional view of the drilling tool taken along line 6-6 in FIG. 2.

FIG. 7 is flowchart illustrating a method of manufacturing the drilling tool of FIG. 1.

FIG. 8 is an exploded view of a drilling tool according to another embodiment of the disclosure.

FIG. 9A is a plan view of a drilling tool according to another embodiment of the disclosure.

FIG. 9B is a plan view of a drilling tool according to another embodiment of the disclosure.

FIG. 9C is a plan view of a drilling tool according to another embodiment of the disclosure.

FIG. 9D is a plan view of a drilling tool according to another embodiment of the disclosure.

FIG. 9E is a plan view of a drilling tool according to another embodiment of the disclosure.

FIG. 9F is a plan view of a drilling tool according to another embodiment of the disclosure.

FIG. 9G is a plan view of a drilling tool according to another embodiment of the disclosure.

FIG. 9H is a plan view of a drilling tool according to another embodiment of the disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

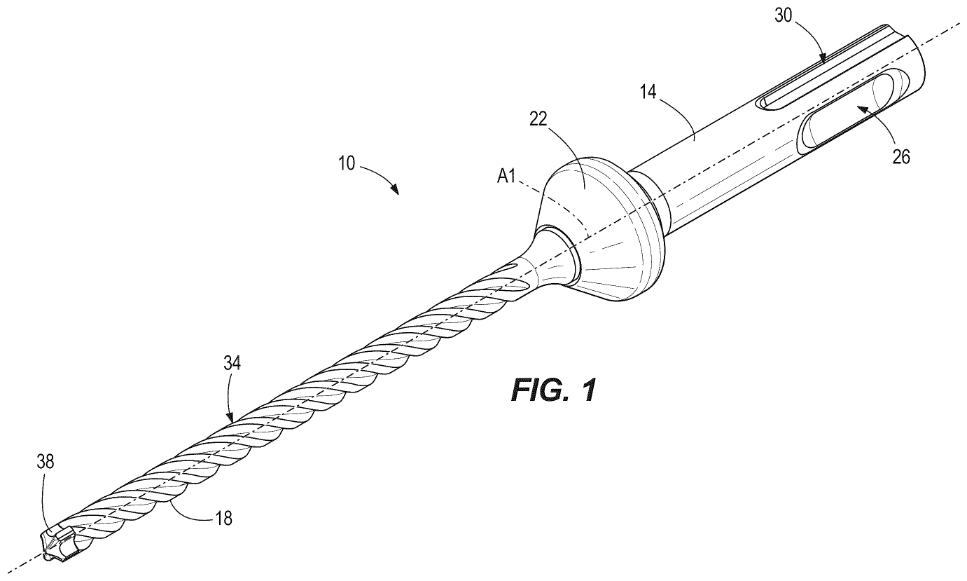

FIG. 1 illustrates a drill bit or drilling tool 10 according to an embodiment of the disclosure. The drilling tool 10 is configured to rotate about an axis of rotation A1 (or longitudinal axis) and includes a shank portion 14, a drill portion 18, and a collar 22 positioned between the shank portion 14 and the drill portion 18. The shank portion 14 is configured to connect the drilling tool 10 to a power tool such as a drill or rotary hammer. The drill portion 18 is configured to engage a workpiece to perform a cutting operation. The collar 22 is positioned between the shank portion 14 and the drill portion 18 to dampen vibrations transferred between the shank portion 14 and the drill portion 18.

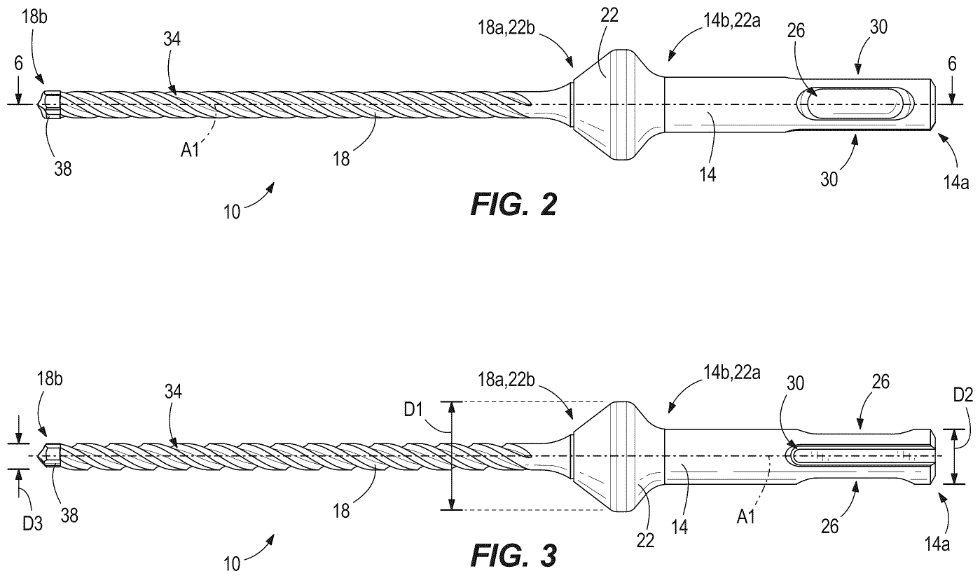

As illustrated in FIGS. 2 and 3, the shank portion 14 is configured as an SDS-style shank, such as an SDS shank, and SDS Plus shank, or an SDS Max shank. In other embodiments, the shank portion 14 may have other configuration, such as a hex shank. The illustrated shank portion 14 includes a shank first end 14a that is configured to be inserted into a power tool to couple the shank portion 14 to the power tool and a shank second end 14b that may be attached to the collar 22. At the shank first end 14a, the shank portion 14 includes a ball detent groove 26 and a torque transmission groove 30. Specifically, the shank portion 14 includes two ball detent grooves 26 and two torque transmission grooves 30. Each of the ball detent grooves 26 is configured to receive a ball detent from a power tool to lock the drilling tool 10 within the power tool. Each of the torque transmission grooves 30 is configured to receive a torque transmission member from the power tool that enables a transfer of torque between the power tool and the drilling tool 10.

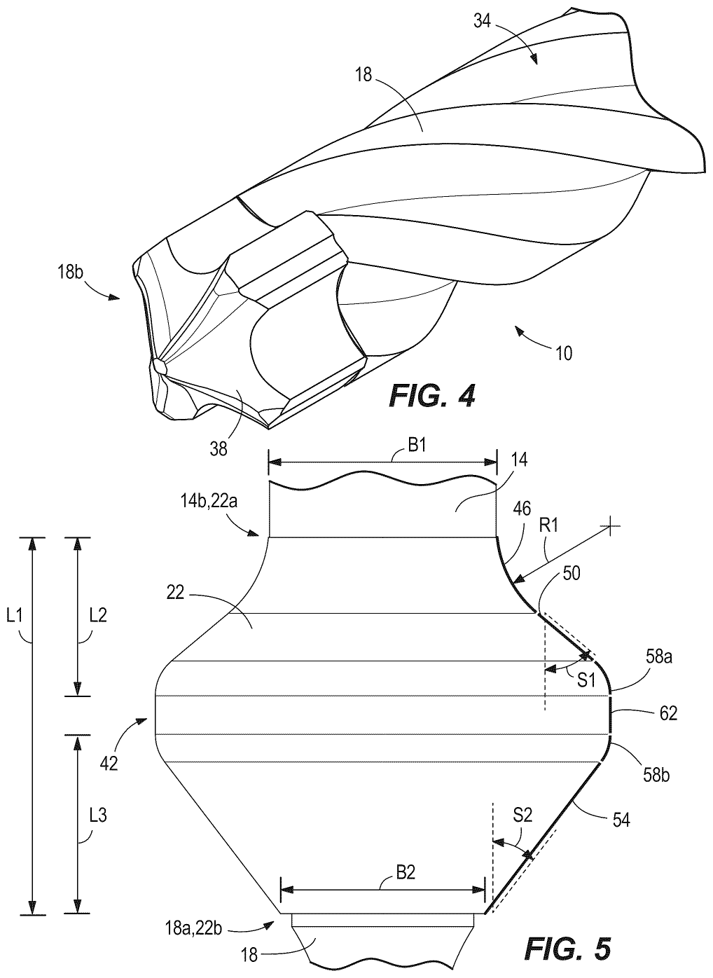

With reference to FIGS. 3 and 4, the drill portion 18 includes a drill first end 18a that may be attached to the collar 22 and a drill second end 18b positioned opposite from the drill first end 18a (e.g., along the axis of rotation A1). The drill portion 18 further includes a plurality of body flutes 34 and a cutting head 38. The body flutes 34 extend between the drill first end 18a and the drill second end 18b of the drill portion 18. In the illustrated embodiment, the body flutes 34 are helically wrapped around the axis of rotation A1. In other embodiments, the body flutes 34 may have other configurations. The cutting head 38 is positioned at the drill second end 18b of the drill portion 18. In the illustrated embodiment, the cutting head 38 is formed as a separate component and attached to the drill portion 18 (e.g., via butt-brazing, welding, etc.). In some embodiments, the cutting head 38 may be integrally formed with the drill portion 18.

The drill portion 18 may have a relatively small outer diameter D3, or cutting diameter. In particular, the outer diameter D3 of the drill portion 18 is less than a maximum outer diameter D2 (or dimension) of the shank portion 14. For example, in some embodiments, the outer diameter D3 of the drill portion 18 may be ⅜ inches or less (i.e., the drilling tool 10 may be a ⅜ inch or smaller drill bit). In other embodiments, the outer diameter D3 of the drill portion 18 may be larger. For example, the outer diameter D3 of the drill portion 18 may be equal to the maximum outer diameter D2 (or dimension) of the shank portion 14 or may be slightly larger than the maximum outer diameter D2 (or dimension) of the shank portion 14.

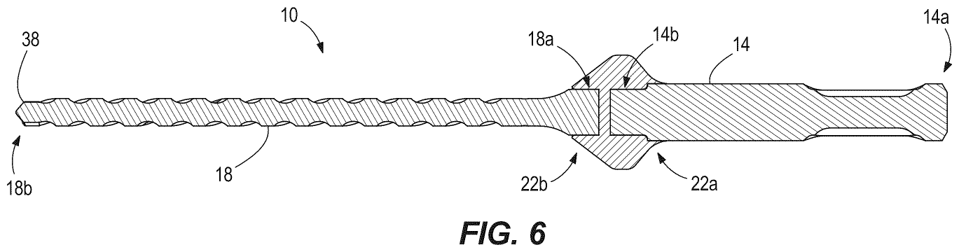

With reference to FIGS. 5 and 6, the collar 22 includes a collar first end 22a, a collar second end 22b, and an apex 42 positioned therebetween. The collar first end 22a is attached to the shank second end 14b, and the collar second end 22b is attached to the drill first end 18a. In the illustrated embodiment, each of the shank portion 14, the drill portion 18, and the collar 22 is formed separately such that the collar 22 effectively couples the shank portion 14 and the drill portion 18 together for co-rotation. In other embodiments, the shank portion 14 and the drill portion 18 may be formed as a unitary body, and the collar 22 may be attached to an intermediate location of the drilling tool 10. In such embodiments, the second end 14b of the shank portion 14 and the first end 18a of the drill portion 18 may not be discrete ends but may be located in the general area where the drilling tool 10 transitions from the shank portion 14 to the drill portion 18. In further embodiments, the shank portion 14 and the collar 22 may be formed as a unitary body and the drill portion 18 may be separately coupled to the collar 22. Alternatively, the drill portion 18 and the collar 22 may be formed as a unitary body and the shank portion 14 may be separately coupled to the collar 22. In yet further embodiments, the shank portion 14, the drill portion 18, and the collar 22 may all be formed as a unitary body.

The apex 42 is the section of the collar 22 having the largest maximum outer diameter. That is, the apex 42 defines the maximum outer dimension of the collar 22. The collar 22 at least partially curves from the collar first end 22a to the apex 42. Specifically, the collar 22 transitions from a curved segment 46 at the collar first end 22a to a first linear segment 50 positioned between the curved segment 46 and the apex 42. The curved segment 46 and the first linear segment 50 form a first transition segment of the collar 22. Additionally, the collar 22 tapers from the collar second end 22b to the apex 42. In other words, the collar 22 includes a second linear segment 54 that extends between the collar second end 22b and the apex 42. The second linear segment 54 forms a second transition segment of the collar 22. As such, the apex 42 is positioned between the collar first end 22a and the collar second end 22b. More specifically, the apex 42 is spaced from each of the collar first end 22a and the collar second end 22b. In the illustrated embodiment, an outer dimension of the collar 22 at each of the collar first end 22a and the collar second end 22b is less than the maximum outer dimension of the collar 22 that is defined at the apex 42 of the collar 22. In other embodiments, the outer dimension of the collar 22 at one or both of the collar first end 22a and the collar second end 22b may be the same as the maximum outer dimension of the collar 22 that is defined at the apex 42. In the illustrated embodiment, the apex 42 is positioned roughly halfway between the collar first end 22a and the collar second end 22b. In other embodiments, the apex 42 may be located unequal distances from the collar first end 22a and the collar second end 22b.

The illustrated apex 42 includes a first rounded edge 58a, a second rounded edge 58b, and a flat segment 62 positioned between the first rounded edge 58a and the second rounded edge 58b. The first rounded edge 58a provides a transition between the first linear segment 50 and the flat segment 62, and the second rounded edge 58b provides a transition between the second linear segment 54 and the flat segment 62. In other embodiments, the apex 42 may have other configurations, such as a rounded transition between the first linear segment 50 and the second linear segment 54 without the flat segment 62.

The curved segment 46 curves from the first end 22a of the collar 22 with a radius R1 in a direction extending away from the first end 22a and away from the axis A1. In the illustrated embodiment, the radius R1 is 5 mm. In other embodiments, the radius R1 may be smaller or larger than 5 mm. For example, the radius R1 may be between 2 mm and 10 mm. In some embodiments, a curved segment may curve from the second end 22b of the collar 22 toward the apex 42 in addition to or in place of the curved segment 46 that curves from the first end 22a of the collar 22. The first linear segment 50 extends from the curved segment 46 to the first rounded edge 58a of the apex 42 at a first angle S1. In the illustrated embodiment, the first angle is 50 degrees. In other embodiments, the first angle S1 may be less than or greater than 50 degrees. For example, the first angle S1 may be between 40 degrees and 60 degrees. The second linear segment 54 extends from the second end 22b of the collar 22 to the second rounded edge 58b of the apex 42 at a second angle S2. In the illustrated embodiment, the second angle S2 is about 37 degrees. More specifically, the second angle S2 is 37.38 degrees. In other embodiments, the second angle S2 may be less than or greater than 37 degrees. For example, the second angle S2 may be between 30 and 40 degrees. The second angle S2 is less than the first angle S1. As such, the collar 22 has a more gradual transition from the drill portion 18 and a more abrupt transition from the shank portion 14. Further, the second linear segment 54 extends a greater distance in a direction extending along the axis A1 than the first linear segment 50. In other embodiments, the collar 22 may have other configurations (e.g., shapes, dimensions, etc.).

As noted above, with reference to FIG. 3, the collar 22 has a maximum outer diameter D1 at the apex 62. The maximum outer diameter D1 is measured perpendicular to the axis A1. The maximum outer diameter D1 of the collar 22 is greater than the outer diameter D2 of the shank portion 14 and the outer diameter D3 of the drill portion 18. For example, in some embodiments, the maximum outer diameter D1 of the collar 22 may be at least 1.5 times as large as the outer diameter D2 of the shank portion 14 and at least 1.5 as large as the outer diameter D3 of the drill portion 18. Stated another way, a ratio of the maximum outer dimension D1 to each of the outer diameter D2 of the shank portion 14 and the outer diameter D3 of the drill portion 18 is at least 1.5. In the illustrated embodiment, the maximum outer diameter D1 of the collar 22 is twice as large as the outer diameter D2 of the shank portion 14 and at least twice as large as the outer diameter D3 of the drill portion 18. Stated another way, a ratio of the maximum outer dimension D1 of the collar 22 to each of the outer diameter D2 of the shank portion 14 and the outer diameter of the drill portion 18 is 2. In the illustrated embodiment, the outer diameter D2 of the shank portion 14 is also greater than the outer diameter D3 of drill portion 18. In such an embodiment, the maximum outer diameter D1 of the collar 22 is about twice as large as the outer diameter D2 of the shank portion 14 and about three times as large as the outer diameter D3 of the drill portion 18. In other embodiments, the outer diameter D2 of the shank portion 14 and the outer diameter D3 of the drill portion 18 may be relatively equal, or the outer diameter D3 of the drill portion 18 may be larger than the outer diameter D2 of the shank portion 14. In some embodiments, the collar 22 may not by cylindrical or circular at the apex 62. As such, the maximum outer diameter D1 may also be referred to as a maximum outer dimension of the collar 22.

With reference to FIG. 5, in the illustrated embodiment, an outer dimension B1 of the collar 22 at the collar first end 22a may be roughly the same as the outer diameter D2 of the shank portion 14. In other embodiments, the outer dimension B1 of the collar 22 at the collar first end 22a may be greater or smaller than the outer diameter D2 of the shank portion 14. In the illustrated embodiment, an outer dimension B2 of the collar 22 at the collar second end 22b may be roughly the same as the outer diameter D3 of the drill portion 18. In other embodiments, the outer dimension B2 of the collar 22 at the collar second end 22b may be greater or smaller than the outer diameter D3 of the drill portion 18.

The collar 22 also has a mass. The mass of the collar 22 may be at least 10 grams. In some embodiments, the mass of the collar 22 may be between 15 grams and 20 grams. More particularly, the mass of the collar 22 may be between 17 grams and 20 grams. In the illustrated embodiment, the mass of the collar 22 is about 18.5 grams. In other embodiments, the mass of the collar 22 may be more than 20 grams.

The collar 22 further has a collar length L1. The collar length L1 is perpendicular to the maximum outer diameter D1. The collar length L1 is measured from the first end 22a to the second end 22b in a direction parallel to the axis A1. In the illustrated embodiment, the collar length L1 is greater than or equal to the outer diameter D2 of the shank portion 14. Specifically, a ratio of the collar length L1 to the outer diameter D2 of the shank portion 14 is at least 1. In some embodiments, a ratio of the collar length L1 to the outer diameter D2 of the shank portion 14 is at least 1.5. In other embodiments, a ratio of the collar length L1 to the outer diameter D2 of the shank portion 14 is at least 2.

The collar 22 also defines a shank transition length L2 from the shank portion 14. The shank transition length L2 is defined between the second end 14b of the shank 14 and the apex 42. In the illustrated embodiment, the shank transition length L2 is at least 0.2 times the outer diameter D2 of the shank portion 14. Stated another way, a ratio of the shank transition length L2 to the outer diameter D2 of the shank portion 14 is at least 0.2. More specifically, a ratio of the shank transition length L2 to the outer diameter D2 of the shank portion 14 is at least 0.5.

The collar 22 also define a drill transition length L3 from the drill portion 18. The drill transition length L3 is defined between the first end 18a of the drill portion 18 and the apex 42. In the illustrated embodiment, the drill transition length L3 is at least the same size as the outer diameter D3 of the drill portion 18. Stated another way, a ratio of the drill transition length L3 to the outer diameter D3 of the drill portion 18 is at least 1. More specifically, a ratio of the drill transition length L3 to the outer diameter D3 of the drill portion 18 is at least 2. In some embodiments, a ratio of the drill transition length L3 to the outer diameter D3 of the drill portion 18 may be at least 3. In the illustrated embodiment, the drill transition length L3 is greater than the shank transition length L2.

The collar 22 is advantageously provided between the shank portion 14 and the drill portion 18 to dampen vibrations that may be transferred between the drill portion 18 and the shank portion 14 during operation of the drilling tool 10. Specifically, the collar 22 may absorb vibrations that travel from the drill portion 18 to the shank portion 14 when, for example, the cutting head 38 of the drill portion 18 is engaged with a workpiece. The collar 22 additionally adds mass to the drilling tool 10 that relieves stress and reduces energy traveling into the body flutes 34. For example, providing the collar 22 with a relatively large cross-section and mass between the shank portion 18 and the drill portion 18 disrupts energy flow from the shank portion 14 to the drill portion 18. Further, the use of gradual transitions, such as the curved segment 46 and the linear segments 50, 54, reduces stress in the tool 10 compared to abrupt transitions in diameter. As such, the collar 22 may reduce fracture for the drilling tool 10 and improve the overall lifespan of the drilling tool 10. The collar 22 may be particularly advantageous for smaller diameter drilling tools (e.g., where the outer diameter D3 of the drill portion 18 is less than the outer diameter D2 of the shank portion 14, such as drill portions 18 having diameters of ⅜ inches or less).

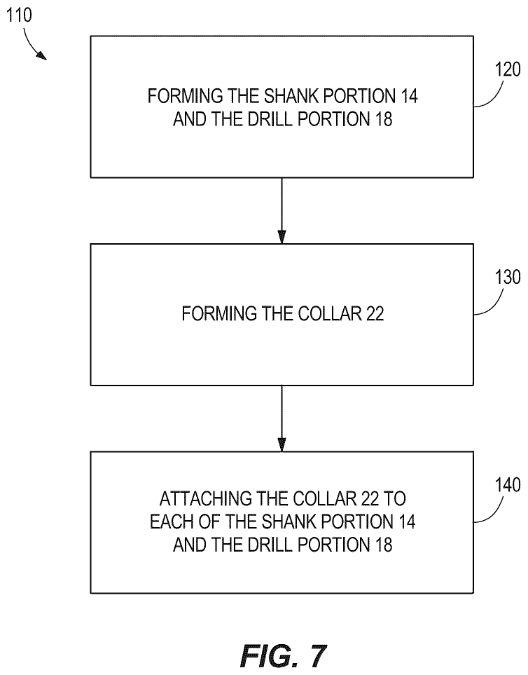

FIG. 7 illustrates a method of manufacturing 110 the drilling tool 10 of FIG. 1. At step 120, with reference to FIGS. 1 and 7, the method 110 includes forming the shank portion 14 and the drill portion 18. In the illustrated embodiment, the shank portion 14 and the drill portion 18 are formed separately. The shank portion 14 and the drill portion 18 may be formed from the same material. For example, the shank portion 14 and the drill portion 18 may each be formed from bar stock (e.g., from different pieces of bar stock). Alternatively, the shank portion 14 and the drill portion 18 may be formed of different materials. Forming the shank portion 14 includes forming the shank portion 14 as an SDS style shank. Forming the drill portion 18 includes forming the body flutes 34 in the drill portion 18. Forming the drill portion 18 additionally includes forming the cutting head 38 separately and attaching the cutting head 38 to an end of the drill portion 18. In other embodiments, the shank portion 14 and the drill portion 18 may be formed together. That is, the shank portion 14 and the drill portion 18 may be formed as a unitary body.

At step 130, with reference to FIGS. 5 and 7, the method 110 includes forming the collar 22. Forming the collar 22 includes forming the curved segment 46 at the first end 22a of the collar 22, forming the first linear segment 50 from the curved segment 46 to the apex 42, forming the apex 42 with the first rounded edge 58a, the second rounded edge 58b, and the flat segment 62, and forming the second linear segment 54 between the apex 42 and the second end 22b of the collar 22. In the illustrated embodiment, the collar 22 is formed separately from the shank portion 14 and the drill portion 18. In some embodiments, the shank portion 14, the drill portion 18, and the collar 22 may all be formed as a unitary body.

At step 140, the method 110 includes attaching the collar 22 to the shank portion 14 and the drill portion 18. In the illustrated embodiment, attaching the collar 22 to the shank portion 14 and the drill portion 18 couples the shank portion 14 and the drill portion 18 for co-rotation together. Attaching the collar 22 may include brazing. Brazing may fill any gaps between the shank portion 14 and the collar 22 and between the drill portion 18 and the collar 22 to provide a solid connection between the shank portion 14, the drill portion 18, and the collar 22. Attaching the collar 22 may additionally or alternatively include a press-fit attachment. Specifically, the collar 22 may be pushed onto each of the shank portion 14 and the drill portion 18 with a force that overcomes a friction force threshold until the collar 22 is secured to each of the shank portion 14 and the drill portion 18 such that the collar 22 cannot be easily removed from either of the shank portion 14 or the drill portion 18. Use of a press-fit may require forming the shank portion 14 and the drill portion 18 with precise and accurate tolerances at the respective ends 14b, 18a of the shank portion 14 and the drill portion 18 to ensure the press-fit occurs. Attaching the collar 22 may additionally or alternatively include heat shrinking. Specifically, the collar 22 may be heated to allow for slight deformation of the collar 22, thereby allowing the shank portion 14 and the drill portion 18 to be inserted into corresponding ends 22a, 22b of the collar 22. With the shank portion 14 and the drill portion 18 inserted, the collar 22 may then be cooled and subsequently hardened around the shank portion 14 and the drill portion 18 to secure the collar 22 to the shank portion 14 and the drill portion 18. Attaching the collar 22 may additionally or alternatively include welding. For example, the shank portion 14 and the drill portion 18 may be inserted into the corresponding ends 22a, 22b of the collar 22 and welded to the collar 22 via laser welding.

In the illustrated embodiment, the collar 22 is formed, as provided above, prior to attaching the collar 22 to each of the shank portion 14 and the drill portion 18. In other embodiments, the collar 22 may be formed after attaching the collar 22 to each of the shank portion 14 and the drill portion 18. That is, for example, a piece of raw material may be attached to each of the shank portion 14 and the drill portion 18, and then the raw material may be formed into the collar 22, as provided above, while the raw material is attached to the shank portion 14 and the drill portion 18.

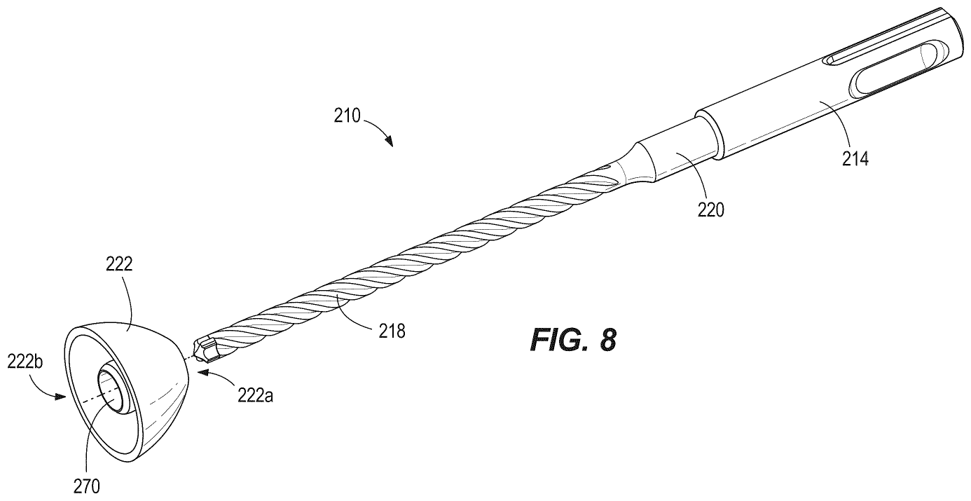

FIG. 8 illustrates a drilling tool 210 according to another embodiment of the disclosure. The drilling tool 210 of FIG. 8 may be substantially similar to the drilling tool 10 of FIG. 1 except for the differences described here. With reference to FIG. 8, the drilling tool 210 includes a shank portion 214, a drill portion 218, an intermediate portion 220 extending between the shank portion 214 and the drill portion 218, and a collar 222. The shank portion 214, the drill portion 218, and the intermediate portion 220 are integrally formed as a unitary body. The collar 222 may be mounted, or attached, to the drilling tool 210 at the intermediate portion 220. As such, the collar 222 is configured to dampen vibrations during operation of the drilling tool 210.

The collar 222 in the illustrated embodiment of FIG. 8 is cup-shaped. As such, the collar 222 may increase in volume between a first end 222a and a second end 222b of the collar 222. Specifically, the collar 222 may increase in volume along the entire length between the first end 222a and the second end 222b. The collar 222 includes an inner sleeve 270 that is configured to directly mount to the intermediate portion 220.

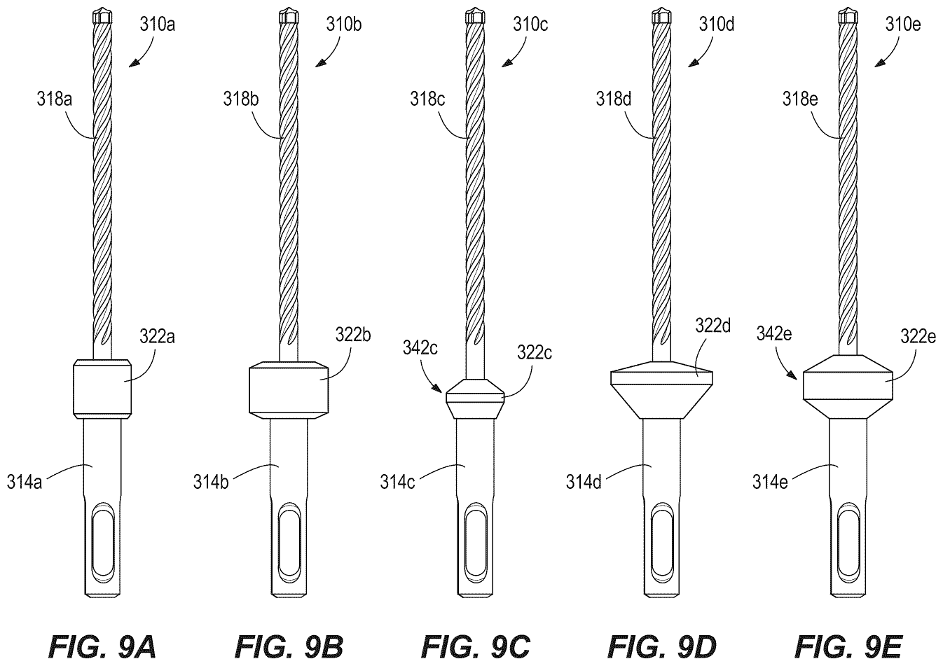

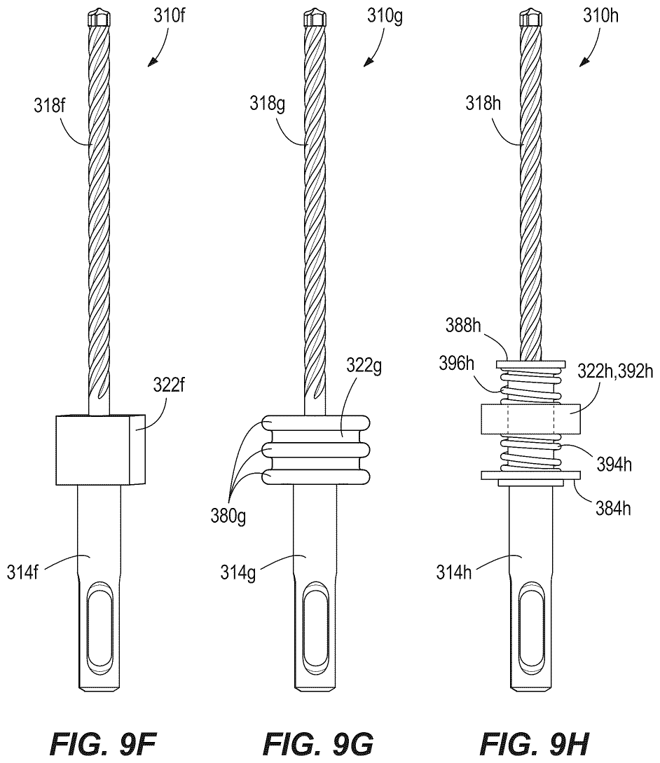

FIGS. 9A-9H illustrate drilling tools having collars according to different embodiments of the disclosure. Each of the drilling tools may be substantially similar to the drilling tool 10 of FIG. 1 and/or the drilling tool 210 of FIG. 8, except for the differences described herein.

FIG. 9A illustrates a drilling tool 310a including a shank portion 314a, a drill portion 318a, and a collar 322a. The collar 322a is substantially cylindrical.

FIG. 9B illustrates a drilling tool 310b including a shank portion 314b, a drill portion 318b, and a collar 322b. The collar 322b is substantially cylindrical and includes tapered ends. The collar 322b of FIG. 9B is relatively wider than the collar 322a of FIG. 9A.

FIG. 9C illustrates a drilling tool 310c including a shank portion 314c, a drill portion 318c, and a collar 322c. The collar 322c includes an apex 342c at the center of the collar 322c. The collar 322c tapers from the ends of the collar 322c to the apex 342c.

FIG. 9D illustrates a drilling tool 310d including a shank portion 314d, a drill portion 318d, and a collar 322d. The collar 322d is substantially frustoconical such that the collar 322d is smaller at an end of the collar 322d adjacent to the shank portion 314d than an end of the collar 322d adjacent to the drill portion 318d.

FIG. 9E illustrates a drilling tool 310e including a shank portion 314e, a drill portion 318e, and a collar 322e. The collar 322e may be substantially similar to the collar 322c of FIG. 9C. That is, the collar 322e includes an apex 342e at the center of the collar 322e. The collar 322e tapers from the ends of the collar 322e to the apex 342e. However, the collar 322e of FIG. 9E is relatively larger than the collar 322c of FIG. 9C.

FIG. 9F illustrates a drilling tool 310f including a shank portion 314f, a drill portion 318f, and a collar 322f. The collar 322f is substantially cube-shaped.

FIG. 9G illustrates a drilling tool 310g including a shank portion 314g, a drill portion 318g, and a collar 322g. The collar 322g is substantially cylindrical and includes three ribs 380g. A first rib 380g is positioned at an end of the collar 322g adjacent to the shank portion 314g, a second rib 380g is positioned at an end of the collar 322g adjacent to the drill portion 318g, and a third rib 380g is positioned between the first and second rib 380g.

FIG. 9H illustrates a drilling tool 310h including a shank portion 314h, a drill portion 318h, and a collar 322h. The collar 322h includes a first plate 384h positioned adjacent to the shank portion 314h, a second plate 388h positioned adjacent to the drill portion 318h, and a center mass 392h positioned between the first plate 384h and the second plate 388h. The collar 322h further includes a first spring 394h positioned between the first plate 384h and the center mass 392h and a second spring 396h positioned between the second plate 388h and the center mass 392h. The first spring 394h biases the center mass 392h away from the first plate 384h, and the second spring 396h biases the center mass 392h away from the second plate 388h. As such, each of the first spring 394h and the second spring 396h may bias the center mass 392h toward the other of the first spring 394h and the second spring 396h. During operation of the drilling tool 310h, center mass 392h may move against the bias of the springs 394h, 396h to dampen vibrations, thereby reducing fractures for the drilling tool 310h.

Although the invention is described with reference to discrete embodiments of a drilling tool, variations of the drilling tool exist within the spirit and scope of the invention. Various features and advantages of the invention are set forth in the following claims.

1. A drilling tool comprising:
a shank portion including a shank first end that is configured to be coupled to a power tool and a shank second end opposite the shank first end;
a drill portion including a drill first end, a drill second end, and a cutting head positioned at the drill second end; and
a collar configured to dampen vibrations transferred between the shank portion and drill portion during operation of the drilling tool, the collar including
a collar first end that is attached to the shank second end,
a collar second end that is attached to the drill first end, and
an apex that defines a maximum outer dimension of the collar, the apex positioned between the collar first end and the collar second end.

2. The drilling tool of claim 1, wherein the apex is spaced from each of the collar first end and the collar second end.

3. The drilling tool of claim 2, wherein an outer dimension of the collar at each of the collar first end and the collar second end is less than a maximum outer dimension of the collar at the apex of the collar.

4. The drilling tool of claim 1, wherein the collar is formed as a separate component from the shank portion, the drill portion, or both.

5. The drilling tool of claim 1, wherein the shank portion has a first diameter, the drill portion has a second diameter, and wherein the maximum outer dimension of the collar is larger than each of the first diameter and the second diameter.

6. The drilling tool of claim 5, wherein the first diameter is larger than the second diameter.

7. The drilling tool of claim 5, wherein a ratio of the maximum outer dimension of the collar to the first diameter is at least 1.5.

8. The drilling tool of claim 5, wherein a ratio of the maximum outer dimension of the collar to the first diameter is at least 2.

9. The drilling tool of claim 1, wherein the drill portion has a drill diameter, wherein the collar has a drill transition length defined between the drill first end and the apex, and wherein a ratio of the drill transition length to the drill diameter is at least 1.

10. The drilling tool of claim 1, wherein the shank portion has a shank diameter, wherein the collar has a collar length, and wherein a ratio of the collar length to the shank diameter is at least 1.

11. A drilling tool comprising:
a shank portion including a shank first end that is configured to be coupled to a power tool and a shank second end opposite the shank first end;
a drill portion including a drill first end, a drill second end, and a cutting head positioned at the drill second end, the drill second end and the shank first end defining a longitudinal axis extending therethrough; and
a collar defining a maximum outer dimension of the drilling tool, the collar including
a collar first end attached to the shank second end,
a collar second end attached to the drill first end, and
a transition segment extending from the collar second end and gradually away from the longitudinal axis.

12. The drilling tool of claim 11, wherein the collar further includes an apex that defines the maximum outer dimension of the collar, and wherein the transition segment is positioned between the apex and the collar second end.

13. The drilling tool of claim 12, wherein the drill portion has a drill diameter, wherein the collar has a drill transition length defined between the drill first end and the apex, and wherein a ratio of the drill transition length to the drill diameter is at least 1.

14. The drilling tool of claim 13, wherein the ratio of the drill transition length to the drill diameter is at least 2.

15. The drilling tool of claim 12, wherein the shank portion has a shank diameter, wherein the collar has a shank transition length defined between the shank second end and the apex, and wherein a ratio of the shank transition length to the shank diameter is at least 0.2.

16. The drilling tool of claim 15, wherein the ratio of the shank transition length to the shank diameter is at least 0.5.

17. The drilling tool of claim 11, wherein the shank portion has a shank diameter, wherein the collar has a collar length, and wherein a ratio of the collar length to the shank diameter is at least 1.

18. A method of manufacturing a drilling tool, the method comprising:
forming a shank portion and a drill portion, the shank portion having a shank first end that is configured to be coupled to a power tool and a shank second end opposite the shank first end, the drill portion having a drill first end, a drill second end, and a cutting head positioned at the drill second end;
forming a collar, the collar including a collar first end and a collar second end; and
attaching the collar to each of the shank portion and the drill portion such that the collar first end attaches to the shank first end and the collar second end attaches to the drill first end.

19. The method of claim 18, wherein the forming the collar includes forming the collar having a maximum outer diameter that is at least 1.5 times as large as a maximum outer dimension of the shank portion and having a length that is greater than or equal to the maximum outer dimension of the shank portion.

20. The method of claim 18, wherein the forming the collar includes forming the collar having a transition segment extending from the collar second end and gradually away from a longitudinal axis of the drilling tool, the transition segment being at least a same size as an outer diameter of the drill portion.
